(19) United States
(12) Patent Application Publication
(10) Pub. No.: US 2015/0127507 A1
(43) Pub. Date: May 7, 2015

(54) COMMODITY AND COLLECTIBLE IDENTIFICATION, VERIFICATION AND AUTHENTICATION MOBILE SYSTEM AND METHODS OF USE

(71) Applicant: David G. Hall, Coto de Caza, CA (US)

(72) Inventor: David G. Hall, Coto de Caza, CA (US)

(21) Appl. No.: 14/073,579

(22) Filed: Nov. 6, 2013

(51) Int. Cl. G06Q 30/06

(52) U.S. Cl. CPC G06Q 30/0627; G06Q 40/04
USPC 705/37

(57) ABSTRACT

A commodity or collectible identification and valuation system is described that includes at least one executable user interface application comprising a commodity or collectible identification method; and at least one device that stores and accesses the at least one executable user interface application. In addition, commodity or collectible conversion methods, as described herein, include: determining the amount of a commodity or the identity of the collectible, determining the type of commodity, if necessary, accessing at least one commodity or collectible database and pricing index that is related to the type of commodity or type of collectible, utilizing the at least one commodity or collectible database and pricing index to calculate the value of the amount of the commodity or of the collectible, transmitting the value of the amount of the commodity or the collectible to the at least one executable user interface application, and displaying the value of the amount of the commodity or the collectible on the at least one device. In some embodiments, the user interface application will provide comparison listings of the collectible at different locations and/or vendors, including quality/grade, price, authenticity, and physical location.

### FIELD OF THE SUBJECT MATTER

The field of the subject matter is the determination of the value and identification of a commodity, collectible, methods and uses thereof, especially those methods and systems that involve mobile applications and applications that can be executed on hand held or wireless devices.

### BACKGROUND

Smart phones, hand-held devices and tablet computers have made it easier for consumers to proactively interact with businesses and get reliable information in real time. In the past, consumers and amateur collectors of commodities, such as gold, silver and platinum coins, were left to the input and calculations of the professional commodities dealer. In other words, the consumer cannot independently verify the information being provided by the dealer or easily and reliably comparison shop in order to find the best coin or commodity and/or the best price for the coin or commodity.

US Patent Publication 2010/023520 discloses an apparatus, system and method for buying and selling interests in at least one coin pool. The apparatus, system and method includes an assessment of at least one coin for inclusion in the at least one coin pool, wherein the at least one coin constitutes legal tender in at least one country, principally precious metals selected from the group of gold, silver, platinum, palladium, and rhodium, an international mintage of less than 10,000, a national mintage limit of at least one of no more than a predetermined threshold mintage and a production limit in a certain timeframe, a non-business strike, a non-bullion, and a proof. This publication also discloses valuing of the at least one coin for a buy in accordance with at least one of a currency exchange value, an award, and a projected value increase, a purchasing of the at least one coin and placing the at least one coin into the at least one pool in accordance with the assessing and the valuing, and an offering of the interests in the coin pool in accordance with said purchasing. This publication is focused on the coins only and not on the underlying commodity—whether it is in coin form or melt form.

CoinTrackers.com includes a system that calculates the value of silver by entering the face value of a bag of coins, a roll of coins or an individual coin. While this system is fine for determining the basic value of silver in a roll of dimes, it is not useful for other metals or commodities, it does not provide additional information, such as grade pricing, it does not provide information with respect to local or online dealers, and it does not allow immediate interface and population of an online sales listing or online auction listing. This application also does not address other commodities, such as sports cards, paper currency, collectibles and other valuable items.

U.S. Pat. No. 6,640,232 entitled “Apparatus and Method for Accessing a Coin Image Compilation” discloses a method of trading a graded object electronically by storing images, making them available to a buyer at a remote terminal who can then purchase the object. Again, this is very limited in that the buyer is at the whim of the vendor database and the vendor itself. The buyer isn't able to comparison shop easily using a database that is updated on the fly and in real time. The buyer also isn't able to set up a wish list and watch list that will interact with various databases to return available commodities as they become available.

To this end, it would be desirable to develop an easy to use, mobile and real-time application whereby a consumer can determine a value of a coin, a collectible, a commodity or a combination thereof. In addition, it would be ideal to allow the consumer to easily link up with desirable online sales, auction and trading outlets in order to sell and/or trade the coin, the commodity, the collectible item or a combination thereof.

### SUMMARY OF THE SUBJECT MATTER

A commodity or collectible identification and valuation system is described that includes at least one executable user interface application comprising a commodity or collectible identification method; and at least one device that stores and accesses the at least one executable user interface application.

In addition, commodity or collectible conversion methods, as described herein, include: determining the amount of a commodity or the identity of the collectible, determining the type of commodity, if necessary, accessing at least one commodity or collectible pricing index that is related to the type of commodity or type of collectible, utilizing the at least one commodity or collectible pricing index to calculate the value of the amount of the commodity or of the collectible, transmitting the value of the amount of the commodity or the collectible to the at least one executable user interface application, and displaying the value of the amount of the commodity or the collectible on the at least one device. In some embodiments, the user interface application will provide comparison listings of the collectible at different locations and/or vendors, including quality/grade, price, authenticity and physical location.

### BRIEF DESCRIPTION OF THE FIGURES

FIG. 1 shows a contemplated commodity or collectible identification and/or valuation method.

FIG. 2 shows a contemplated commodity or collectible identification and/or valuation method.

FIG. 3 shows a contemplated commodity or collectible identification and/or valuation method.

### DETAILED DESCRIPTION

An easy to use, mobile and real-time application has been developed whereby a consumer can determine a value, identification, location, seller/owner or a combination thereof of a metal, commodity, collectible or a combination thereof. In addition, the consumer can be easily linked up with desirable online sales, auction and trading outlets in order to sell and/or trade the metal, commodity, collectible or combination thereof. Some contemplated embodiments also allow for the immediate, full and easy population of various pieces of information into the online sales, trade or auction listing.

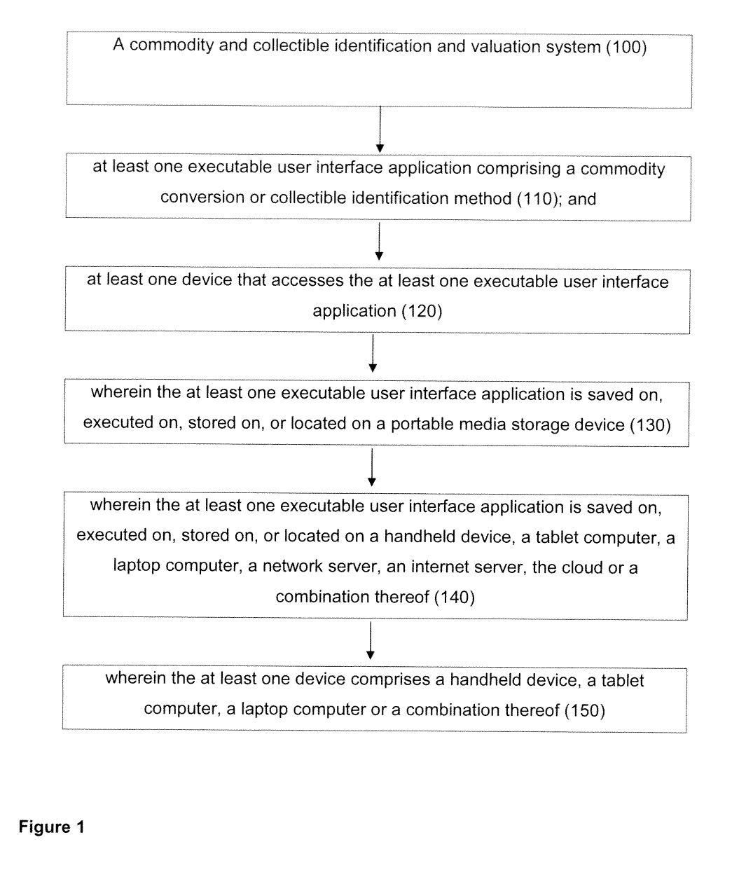

Specifically, and as shown in FIG. 1, a mobile commodity or collectible identification and valuation system 100 is described that includes at least one executable user interface application comprising a commodity conversion and collectible identification method 110; and at least one device that accesses the at least one executable user interface application and/or software platform 120. Contemplated applications and/or software platforms can be built for and used on any number of suitable devices and interfaces, including mobile applications and devices, internet applications, network applications, phone and smartphone devices, trade show and convention applications.

Contemplated systems embodiments and related applications or apps are saved on, executed on, stored on or located on a portable media storage device 130, a hand held device, a tablet computer, a laptop computer, a desk top computer, a network server, an internet server, the cloud or a combination thereof 140. Contemplated devices 150 may include a smart phone, hand held device, laptop computer or another suitable device with a network connection, data transfer connection, network data connection, cellular data network and/or connection, Wi-Fi connection, wireless connection, or another suitable device/link combination or connection that allows the user to access the at least one executable user interface application comprising a commodity conversion method.

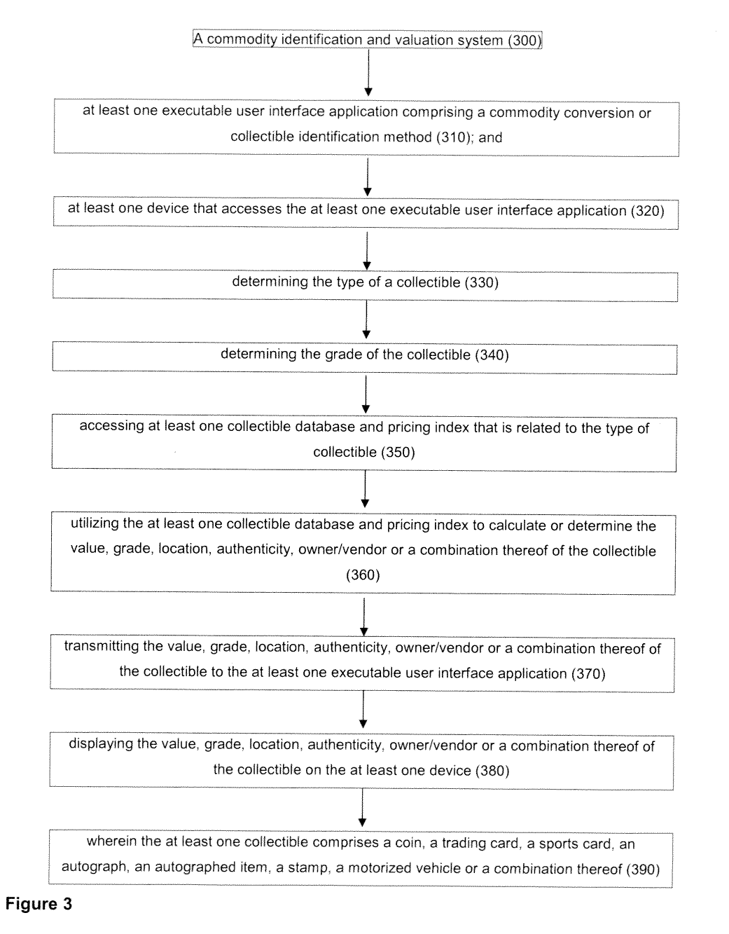

In some contemplated embodiments, the collectible item (shown as 390 in FIG. 3) comprises a coin, a paper currency, a trading card, a sports card, an autograph, an autographed item, a stamp, a motorized vehicle or a combination thereof. In a specific embodiment, the trading card comprises a sports trading card, such as a baseball trading card, a football trading card, a hockey trading card, a basketball trading card or another suitable sports trading card.

Contemplated collectible items can be cataloged or otherwise linked together by utilizing an archived collection, a database or a combination thereof. Contemplated archived collections, databases or other suitable electronic/digital cataloging system allows the user to access the collectible title, photo or image, brief and/or detailed description, estimated or confirmed value, recent sales price, number available, quality, and any other desirable or necessary commodities or collectibles information for both the vendor and consumer. Contemplated archived collections, databases or other suitable electronic/digital cataloging system are stored on any suitable electronic or digital storage medium or media.

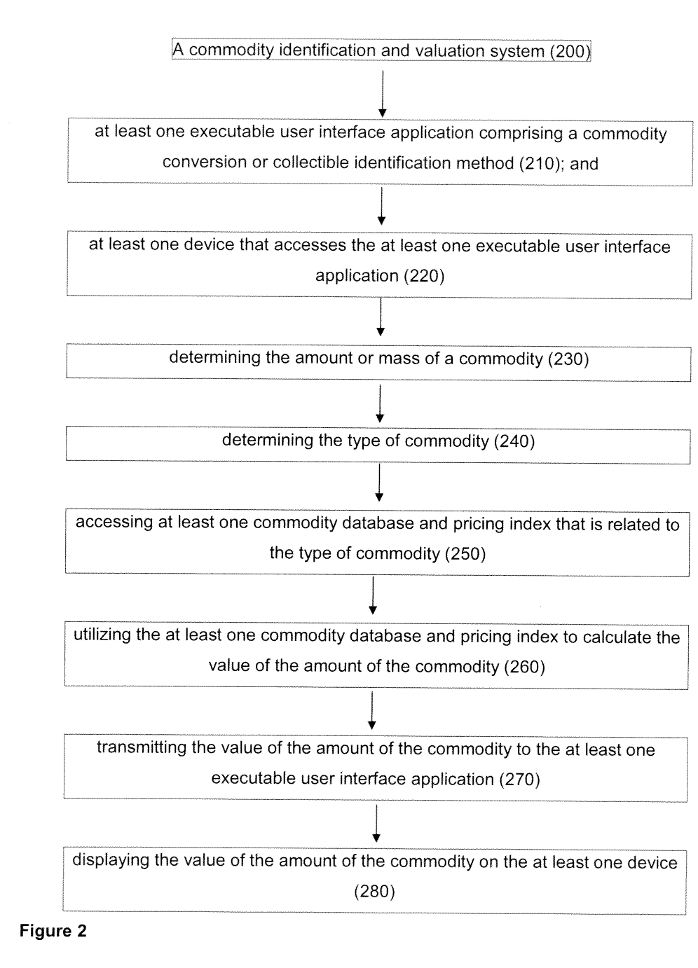

In addition and as shown in FIGS. 2 and 3, commodity conversion 200 and collectible identification 300 methods, as described herein, include: determining the amount or mass of a commodity 230, determining the type of commodity 240, determining the type of collectible 330, determining the grade or condition of the collectible 340, accessing at least one commodity or collectible database and pricing index that is related to the type of commodity or collectible 250 or 350, utilizing the at least one commodity or collectible database and pricing index to calculate the value of the amount of the commodity 260 or 360, the identity and/or authenticity of the collectible, the value of the collectible or a combination thereof, transmitting 270 or 370 the a value, identification, location, seller/owner of the commodity or collectible to the at least one executable user interface application, and displaying 280 or 380 the a value, identification, location, seller/owner of the commodity or collectible on the at least one device.

The determination of the a value, identification, location, authenticity, seller/owner of commodity or collectible can be as easy as the user of the method inputting the material (such as “gold” or “silver”) manually into a text box, selecting the commodity or material from a drop-down box, uploading a file or information from another source (such as a coin from the PCGS® coin database), or by answering a series of targeted questions for those who may have found a potentially valuable item, but isn't exactly sure what it is. The a value, identification, location, authenticity, seller/owner of a collectible can also be determined by entering the information into a text box or taking a picture of the collectible, uploading it to application and executing the application.

The amount of a contemplated commodity or type of collectible can be represented and inputted in a number of different ways. With respect to the amount itself, any suitable mass or weight is contemplated, and any suitable units can be presented in a drop-down menu or searchable menu as a part of the application. The type of collectible can be represented and inputted a number of different ways as well, including the type of collectible (coin, card, car, etc) and more specific information, such as the year, potential or suspected grade, etc. It should also be understood that the collectible can be can be inputted by using the handheld device or another method to produce a digital photo or image of the item and upload it, so that it can be analyzed and identified by the application. The image may be of the actual collectible itself or it may be a stock image of a similar collectible.

And, as alluded to herein, the amount can be inputted in any suitable manner, including inputting a numerical amount and selecting a unit from a drop-down menu, such as grams, ounces, Troy ounces, grains etc. In other embodiments, an amount can be inputted into a text box and the unit inputted into a second and searchable text box. If the commodity to be valued is in fact a coin or stamp, the year or other information can be inputted into the “amount” piece of the method, so that the proper commodity index and/or database can be accessed.

In the case of a commodity, a contemplated device may be interfaced with a scale or mass-determination device, such that the mass is automatically transmitted to the device and automatically populated into the commodity conversion method. In these embodiments, the scale or mass-determination device may be connected with the user device by a hard wire or may be wirelessly accessible by the user device that comprises the commodity conversion method.

Contemplated methods can access at least one suitable commodity or collectible index to obtain the most current and/or real-time authentication, valuation and grade information. In the instance where there are several potential values (such as for a coin having various degrees of grade or a card having a particular year or condition), these values can be displayed separately (each coin grade with its corresponding value) or can be averaged and displayed as one value (in those embodiments where there are multiple indexes having values for a particular metal). In addition, information may be gained through the use of a web-crawl, a search spider, a RSS feed crawler, a news crawler, a valuation crawler, a keyword alert system, currency fluctuation comparators, or the like, as will be understood by those skilled in the art.

In contemplated embodiments, the value or values of the amount or type of the commodity or the value, identification, location, seller/owner of a particular collectible is transmitted to the at least one executable user interface application through a communication channel. Contemplated communication channels can be telephone or audio, video, Wi-Fi, wireless data transmission, wireless internet, hardwire broadband internet, digital communications, or a combination thereof.

As contemplated herein, at least part of the contemplated methods and systems utilize, access and/or store information on at least one shared network infrastructure. Contemplated shared network infrastructures include the internet or a web service, the Cloud, a network structure, a grid-computing system, a mainframe computer system, a utility computing system, a peer-to-peer architecture system or a combination thereof.

In contemplated embodiments, the value of the amount or values of the grades of the commodity or the value, identification, location, seller/owner of a collectible is displayed on the at least one device. It should be understood that the term “displayed” may encompass text, links, audio, video or a combination thereof. For example, someone who is sight-impaired may utilize audio “display” of the information on his or her device.

Once the information is displayed on the device, there are several additional options available to the user. First and most simply, the user may use the information to communicate with a dealer in order to negotiate a final price for a commodity or the collectible. Second, the information that is displayed may show, in some embodiments, a list of dealers in the area and/or online that are also interested in purchasing this particular commodity or collectible. Third, the display may include a link that will direct the user immediately to an online sales portal or online auction website, such as E-Bay. In this instance, contemplated commodity or collectible identification and valuation systems may populate the user's information, the commodity information, and any other suitable information to ensure that the listing is correct, easily set-up and efficiently displayed. The system will then notify the user of bids or interest in the commodity—once it has been listed.

### EXAMPLES

### Example 1

### Coin Valuation—1901 Morgan Silver Dollar

The 1901 Morgan Silver Dollar information is added, along with a potential grade of the coin, into the application that is loaded and opened on a handheld device. In this embodiment, the 1901 Morgan Silver Dollar is entered into the text box. The commodity identification application returns the pricing for various grades of the coin. The user also has links to the grading, which can help the user determine the grade of the physical coin.

### Example 2

### Collectible Valuation—Michael Jordan Autographed Basketball

A potential purchaser comes across a Michael Jordan Autographed Basketball at a trade show; however, it is unclear if it is authentic. In addition, if it is authentic, it is unclear what the standard value is on the collectible. The purchaser uses his Samsung smart phone to take a digital image of the autographed ball. The purchaser opens the commodity and collectible identification and valuation app on his smart phone and uploads the picture to the app. The app compares the autograph to a database and collectible pricing index to a) authenticate the autograph, b) determine the grade of the autograph, and c) if authentic, to provide an estimated value of the autographed item to the potential purchaser.

Thus, specific embodiments, methods and uses of the determination of the value, grade and/or type of a commodity, collectible or combination thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A commodity and collectible identification and valuation system, comprising:
at least one executable user interface application comprising a commodity conversion or collectible identification method, wherein the collectible identification method includes imputing or uploading an image of a commodity into the application;
at least one device that accesses the at least one executable user interface application;
determining the type of a collectible,
determining the grade of the collectible,
accessing at least one collectible database and pricing index that is related to the type of collectible,
utilizing the at least one collectible database and pricing index to at least in part to determine the value, grade, location, authenticity, owner/vendor or a combination thereof of the collectible,
transmitting the value, grade, location, authenticity, owner/vendor or a combination thereof of the collectible to the at least one executable user interface application, and
displaying the value, grade, location, authenticity, owner/vendor or a combination thereof of the collectible on the at least one device.

2. The commodity and collectible identification and valuation system of claim 1, wherein the at least one executable user interface application is saved on, executed on, stored on, or located on a portable media storage device.

3. The commodity and collectible identification and valuation system of claim 1, wherein the at least one executable user interface application is saved on, executed on, stored on, or located on a handheld device, a tablet computer, a laptop computer, a network server, an internet server, the cloud or a combination thereof.

4. The commodity and collectible identification and valuation system of claim 1, wherein the at least one device comprises a handheld device, a tablet computer, a laptop computer or a combination thereof.

5-8. (canceled)

9. The commodity identification and valuation system of claim 1, wherein the at least one collectible listing application comprises a system that initiates communication with an online sales portal, online auction portal or a combination thereof.

10. The commodity identification and valuation system of claim 1, wherein the at least one collectible comprises a coin, a trading card, a sports card, an autograph, an autographed item, a stamp, a motorized vehicle or a combination thereof.

11. The commodity identification and valuation system of claim 1, wherein the at least one collectible comprises an autograph, an autographed item, or a combination thereof.

12. The commodity identification and valuation system of claim 1, wherein the at least one collectible comprises a coin.

13. The commodity identification and valuation system of claim 1, wherein the at least one collectible comprises a trading card, a sports card, a stamp or a combination thereof.
